(19) United States
(12) Patent Application Publication
(10) Pub. No.: US 2008/0118116 A1
(43) Pub. Date: May 22, 2008

(54) SYSTEMS AND METHODS FOR TRACKING A SURGICAL INSTRUMENT AND FOR CONVEYING TRACKING INFORMATION VIA A NETWORK

(75) Inventors: Jason Rene Chandonnet, Lowell, MA (US); Jon Thomas Lea, Hampstead, NH (US); Nicholas Robert, Boston, MA (US); Joel Frederick Zuhars, Haverhill, MA (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/561,678

(22) Filed: Nov. 20, 2006

(51) Int. Cl. G06K 9/00

(52) U.S. Cl. 382/128

(57) ABSTRACT

Systems and methods for tracking a surgical instrument and for conveying tracking information via a network provide a primary tracking image generally within an operating room, and also a variety of types of secondary tracking images, either outside of the operating room or within the operating room.

### CROSS REFERENCE TO RELATED APPLICATIONS

Not Applicable.

### STATEMENT REGARDING FEDERALLY SPONSORED RESEARCH

Not Applicable.

### FIELD OF THE INVENTION

This invention relates generally to tracking systems and methods used to track a surgical instrument and, more particularly, to systems and methods used to track a surgical instrument that convey tracking information via a network.

### BACKGROUND OF THE INVENTION

Tracking (or navigation) systems that can track the position of a surgical instrument within the body during a medical procedure are known. The tracking systems employ various combinations of transmitting antennas and receiving antennas adapted to transmit and receive electromagnetic energy. Some types of conventional tracking system are described in U.S. patent application Ser. No. 10/611,112, filed Jul. 1, 2003, entitled “Electromagnetic Tracking System Method Using Single-Coil Transmitter,” U.S. Pat. No. 7,015,859, issued Mar. 21, 2006, entitled “Electromagnetic Tracking System and Method Using a Three-Coil Wireless Transmitter,” U.S. Pat. No. 5,377,678, issued Jan. 3, 1995, entitled “Tracking System to Follow the Position and Orientation of a Device with Radiofrequency Fields,” and U.S. Pat. No. 5,251,636, issued Oct. 12, 1993, entitled “Stereoscopic X-Ray Fluoroscopy System Using Radiofrequency Fields.”

Some tracking systems have been adapted to track flexible probes inserted into the body for minimally-invasive surgeries, for example, nasal surgeries. One such system is described in U.S. Pat. No. 6,445,943, issued Sep. 3, 2002, entitled “Position Tracking System for Use in Medical Applications.” Each of the aforementioned patent applications and patents are incorporated by reference herein in the entirety.

The above-mentioned systems generally use one or more antennas positioned on a surgical instrument, which transmit electromagnetic energy, and one or more antennas positioned near a patient to receive the electromagnetic energy. Computational techniques can resolve the position, and in some systems, the orientation, of the surgical instrument. The systems are generally reciprocal, so that the transmitting antennas can be interchanged with the receiving antennas.

Conventional tracking systems are stand alone systems and provide a so-called tracking image directly to a surgeon or other staff within an operating room. Those outside of the operating room are not able to view the tracking image, to alter the tracking image, or to generate a different tracking image.

It would, therefore, be desirable to convey tracking information outside of the operating room to others, who may, in some arrangements, provide assistance to the surgeon in the operating room.

### SUMMARY OF THE INVENTION

The present invention conveys tracking information outside of the operating room to others via a network, who may, in some arrangements, provide assistance to the surgeon in the operating room.

In accordance with one aspect of some embodiments the present invention, a method of generating a tracking image includes receiving first raw image data with a primary imaging and tracking system. The method further includes communicating upon a network at least one of the first raw image data, first position and orientation data, first transformed position and orientation data, or first registration matrix data. The first position and orientation data is associated with a first coordinate system and the first raw image data is associated with a second coordinate system. The first raw tracking data is representative of raw information provided by a first tracking sensor adapted to track a primary surgical instrument. The first position and orientation data is indicative of a position and orientation of the primary surgical instrument in the first coordinate system. The first transformed position and orientation data is indicative of a transformed position and orientation of the primary surgical instrument in the second coordinate system. The first registration matrix data is representative of a transformation from the first coordinate system to the second coordinate system. The method further includes displaying with the primary imaging and tracking system a primary tracking image indicative of the first transformed position and orientation data associated with the primary surgical instrument combined with the first raw image data.

In accordance with another aspect of some embodiments of the present invention, a system for generating a tracking image includes a primary imaging and tracking system adapted to receive first raw image data. The primary imaging and tracking system is further adapted to communicate upon a network at least one of the first raw image data, first raw tracking data, first position and orientation data, first transformed position and orientation data, or first registration matrix data. The first position and orientation data is associated with a first coordinate system and the first raw image data is associated with a second coordinate system. The first raw tracking data is representative of raw information provided by tracking sensors. The first position and orientation data is indicative of a position and orientation of a primary surgical instrument in the first coordinate system. The first transformed position and orientation data is indicative of a transformed position and orientation of the primary surgical instrument in the second coordinate system. The first registration matrix data is representative of a transformation from the first coordinate system to the second coordinate system. The primary imaging and tracking system is further adapted to display a primary tracking image indicative of the first transformed position and orientation data associated with the primary surgical instrument combined with the first raw image data.

In accordance with another aspect of some embodiments of the present invention, a system for generating a tracking image includes a primary imaging and tracking system adapted to couple to a network and adapted to communicate tracking data to or from the network. The tracking data is associated with a position and an orientation of a surgical instrument.

In accordance with another aspect of some embodiments of the present invention, a method of generating a tracking image includes communicating tracking data to or from a network associated with a primary imaging and tracking system. The tracking data is associated with a position and an orientation of a surgical instrument.

### BRIEF DESCRIPTION OF THE DRAWINGS

The foregoing features of the invention, as well as the invention itself may be more fully understood from the following detailed description of the drawings, in which:

FIG. 1 is a block diagram showing an exemplary primary imaging and tracking system in association with an image generator, a tracking system, and a network;

FIG. 1A is a block diagram showing an exemplary secondary imaging and tracking system in association with the network of FIG. 1; and

FIG. 1B is a block diagram showing another exemplary secondary imaging and tracking system in association with the network of FIG. 1.

### DETAILED DESCRIPTION OF THE INVENTION

Before describing the present invention, some introductory concepts and terminology are explained. As used herein, the term “raw image data” or “RID” is used to describe a digital signal representative of a “raw image” of a patient. The RID can include, but is not limited to, image data associated with a computer-aided tomography (CT) system, an x-ray system, a x-ray fluoroscopy system, a magnetic resonance imaging (MRI) system, a positron emission tomography (PET) system, an optical imaging system (e.g., an infra-red imaging system), or a nuclear imaging system. The RID alone can be used to generate the raw image of the patient, which may or may not include a direct image of a surgical instrument. From discussion below, it will be understood that the raw image data is associated with an image (or second) coordinate system.

As used herein, the term “tracking image” is used to describe an image of a patient that includes an indication of a position, and in some arrangements, also an orientation of, a surgical instrument, in combination with a raw image associated with the RID. For example, a tracking image can show the position and orientation of the surgical instrument as a pointer overlaid upon a CT image. However, other representations of the position and orientation of the surgical instrument in combination with the raw image are also possible.

As used herein, the term “tracking sensor analog signals” or “TSAs” is used to describe analog signals that are associated with tracking sensors, i.e., antennas, used in conjunction with a tracking system. The TSAs are shown and described herein to be associated with tracking sensors that are disposed outside of a patient. However, as described above, many tracking systems are reciprocal, and the tracking sensors can instead be coupled to a surgical instrument, wherein the TSAs are communicated by the tracking sensors within the patient.

As used herein, the term “raw tracking data” or “RTD” is used to describe a digital signal representative of pre-processed TSAs. The preprocessing can include, for example, amplification and demultiplexing. Exemplary pre-processing of TSAs is described for example, in one or more of U.S. patent application Ser. No. 10/611,112, filed Jul. 1, 2003, entitled “Electromagnetic Tracking System Method Using Single-Coil Transmitter,” U.S. Pat. No. 7,015,859, issued Mar. 21, 2006, entitled “Electromagnetic Tracking System and Method Using a Three-Coil Wireless Transmitter,” U.S. Pat. No. 5,377,678, issued Jan. 3, 1995, entitled “Tracking System to Follow the Position and Orientation of a Device with Radiofrequency Fields,” and U.S. Pat. No. 5,251,636, issued Oct. 12, 1993, entitled “Stereoscopic X-Ray Fluoroscopy System Using Radiofrequency Fields, each of which is incorporated by reference herein in its entirety.

In some embodiments, the RTD is representative of magnitudes of signals received by a plurality of tracking sensors.

As used herein, the term “position and orientation” data or “P&O” data is used to describe digital data indicative of a position and orientation of a surgical instrument in a first (or tracker) coordinate system. The P&O data is generated by performing a so-called “tracking algorithm” upon the RTD.

As used herein, the terms “registered” and “transformed” are both used to describe data in a second coordinate system that is transformed from data in a first coordinate system. The two coordinate systems can be any coordinate systems, for example, rectangular or polar coordinate systems.

Accordingly, as used herein, the term “transformed position and orientation” data or “TP&O” data is used to describe digital data indicative of a transformed position and orientation of the primary surgical instrument in a second (or image) coordinate system. The TP&O data is generated by transforming the P&O data, essentially converting the P&O data from data in the first coordinate system to transformed data in the second coordinate system. Since the above-described raw image data (RID) is also in the second coordinate system, the transformed position and orientation data can be combined with the raw image data, or “fused” to provide the tracking image.

As used herein, the term “registration matrix” is used to describe a matrix having matrix values (the registration matrix can, in some embodiments, be a one-dimensional matrix or vector) that can be combined with the P&O data to generate the transformed P&O data. Therefore, it will be understood that the registration matrix is representative of and provides a transformation from the first coordinate system to the second coordinate system.

As used herein, the term “real-time” is used to describe computer operations that are performed without appreciable delay, for example, at the speed of the computer processing, or at the speed of computer communications or display.

As used herein, the term “phantom” or “phantom patient” is used herein to describe an artificial body part or an entire artificial patient that can represent a real body part or real patient.

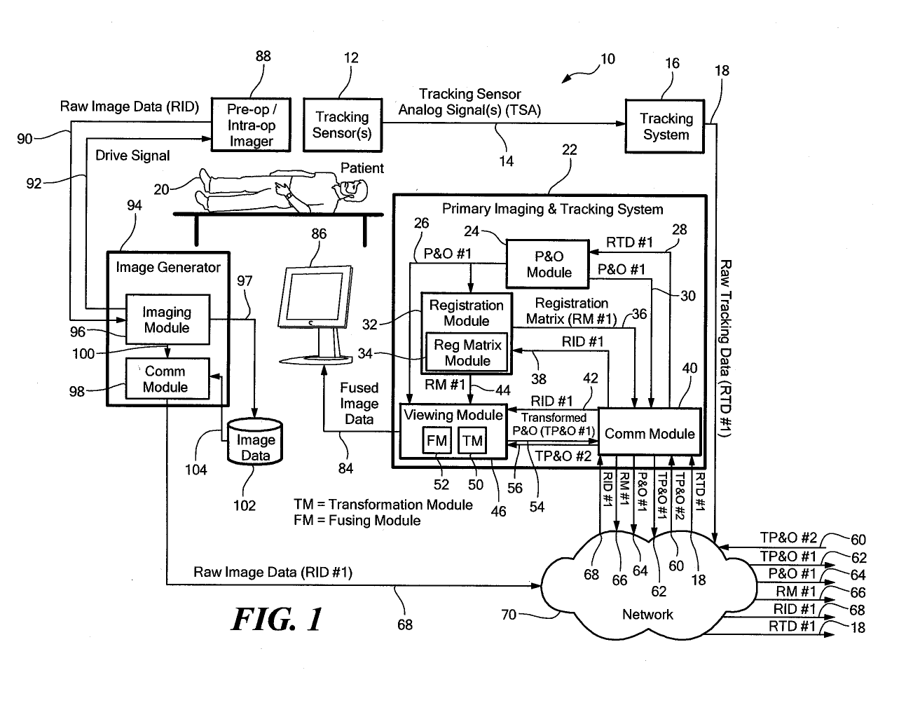

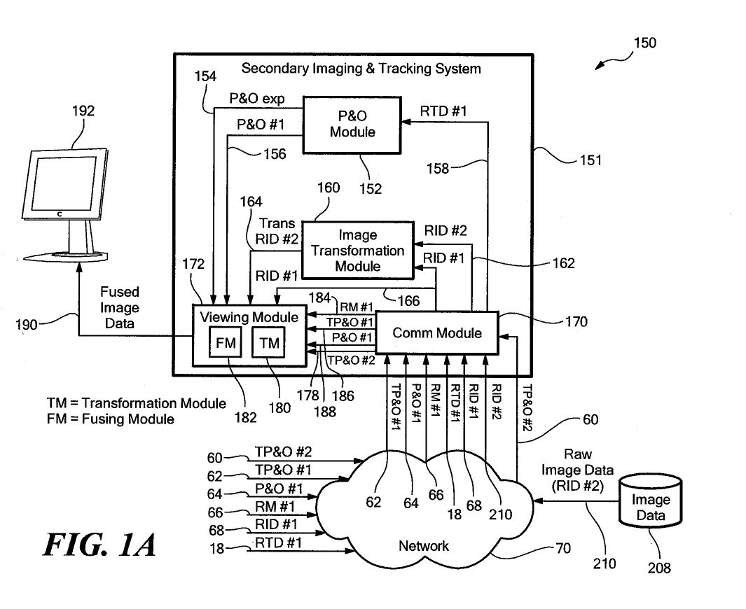

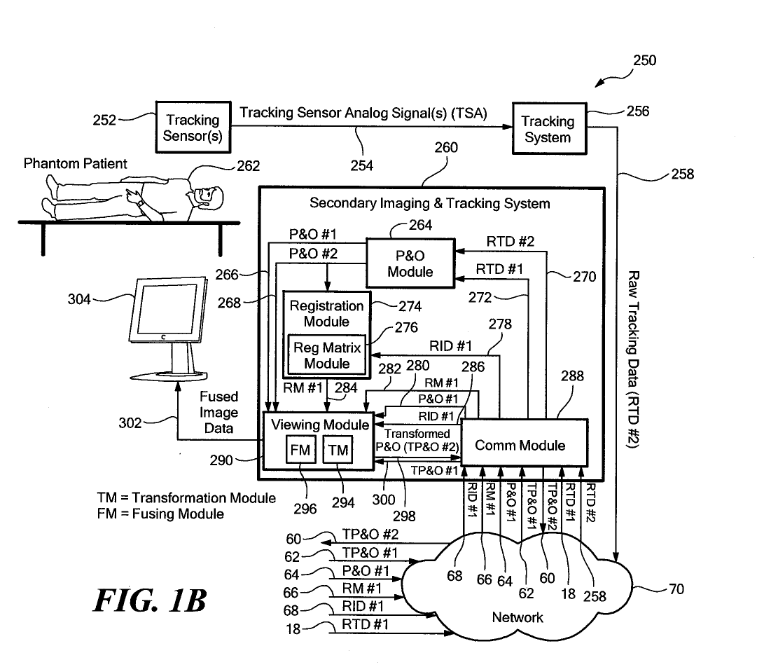

The term “primary” is used in various examples below to describe methods and 10 apparatus used directly by a surgeon during a surgical procedure, for example, a primary imaging and tracking system as in FIG. 1. The term “secondary” is used in various examples below to describe methods and apparatus used indirectly by another during a surgical procedure or at another location during the surgical procedure, for example, a secondary imaging and tracking system as in FIGS. 1A and 1B. However, the terms are used for clarity only, and the secondary methods and apparatus could be used at any location, including by the surgeon in the operating room during a surgical procedure. Furthermore, the primary imaging and tracking system could be used at any location, including outside of the operating room.

As used herein, the term “network” is used to describe, for example, a local area network, or a wide area network, including, but not limited to, the Internet.

Referring to FIG. 1, an exemplary system 10 includes a tracking sensor(s) 12, which can receive electromagnetic energy from a surgical instrument (not shown) generally within a patient 20, resulting in a tracking sensor analog signal(s) (TSAs) 14. The system 10 further includes a tracking system 16 adapted to receive the TSAs 14 and to generate first raw tracking data (RTD #1) 18, which, in some embodiments, can be provided to a primary imaging and tracking system 22 via a network 70. However, in some other arrangements, the RTD #1 18 is provided directly to the primary imaging and tracking system 22 via a direct link.

In some embodiments, the system 10 also includes a pre-operation/intra-operation imager 88 coupled to an image generator 94. The pre-operation/intra-operation imager 88 and the image generator 94 can be respective parts of a conventional imaging system, including, but not limited to a computer-aided tomography (CT) system, an x-ray system, a x-ray fluoroscopy system, a magnetic resonance imaging (MRI) system, a positron emission tomography (PET) system, an optical imaging system (e.g., an infra-red imaging system), or a nuclear imaging system. The imaging generator 94 can provide a drive signal 92 to the pre-operation/intra-operation imager 88 and can receive first raw image data (RID #1) 90 from the pre-operation/intra-operation imager 88.

The image generator 94 can include an imaging module 96 adapted to provide raw image data 97 to an image data repository 102 and adapted to provide raw image data 100, the same as or similar to the raw image data 97, to a communications module 98. The raw image data 97 can be stored in the image data repository 102 and corresponding stored raw image data 104 can be recalled from the image data repository 102.

The communications module 98 can be coupled to receive the stored raw image data 104 from the image data repository 102 and also the raw image data 100 from the imaging module 96. Accordingly, the communications module 98 is adapted to provide first raw image data (RID #1) 68. With this arrangement, it will be understood that the RID #1 68 can be comprised of either the raw image data 100 or the stored raw image data 104, wherein the raw image data 100 can be the same as the raw image data 90, collected in real-time, and the stored raw image data 104 can be raw image data 97 that was stored at an earlier time, but which corresponds to an image of the patient 20.

The RID #1 68 can be transported on the network 70 to the primary imaging and tracking system 22. However, in other arrangements, the RID #1 68 can be provided to the primary imaging and tracking system 22 in other ways, including, but not limited to, via a floppy disk, a compact disk (CD), a digital video disk (DVD), a magnetic tape, a direct wire, or a direct wireless link.

The primary imaging and tracking system 22 can include a communications module 40 adapted to receive the RTD #1 18 and the RID #1 68 transported by the network 70. The communications module 40 can also be adapted to receive second transformed position and orientation data (TP&O #2) 60 transported on the network 70. The TP&O #2 60 is described more fully below in conjunction with FIG. 1B. Let it suffice here to say that the TP&O #2 data can be representative of a transformed position and orientation of another surgical instrument at another location.

The communications module can also be coupled to provide at least one of first registration matrix (RM #1) data 66, first position and orientation (P&O #1) data 64, or first transformed position and orientation (TP&O #1) data 62 for transport on the network 70, each of which is described more fully below.

The primary imaging and tracking system 22 can further include a P&O module 24 coupled to the communications module 40, a registration module 32 coupled to the communications module 40 and to the P&O module 24, and a viewing module 46 coupled to the communications module 40, to the registration module 32, and to the P&O module 24. The viewing module can be further coupled to an imaging device 86, for example, a computer monitor.

The registration module 32 can include a registration matrix module 34. The viewing module 46 can include a transformation module 50 and a fusing module 52.

In operation, the communications module 40 receives the RTD #1 18 transported by the network 70 and sends corresponding RTD #1 28, the same as or similar to the RTD #118, to the P&O module 24. The P&O module 24 processes the RTD #128 with a tracking algorithm, to provide P&O #1 data 26 to the registration module 32 and to the viewing module 46. In some arrangements, the P&O #1 data 26 can be provided to the registration module 32 only at the time of registration, described more fully below, and not throughout theprocedure.

To be used during a surgical procedure, the tracking algorithm generally must be approved by a government agency, for example by the Food and Drug Administration (FDA). The P&O module 24 also provides P&O #1 data 30, the same as or similar to the P&O data 26, to the communications module 40. The communications module 40 provides the P&O #1 data 64, the same as or similar to the P&O #1 data 26, for transport on the network 70. The P&O #1 data 26, 30, 64 is indicative of a position and an orientation of the above-described surgical instrument is in a first (or tracker) coordinate system.

While position and orientation data is describe herein, it should be appreciated that, in some embodiments, the position and orientation data can be replaced by position data indicative of only a position (and not an orientation) of a surgical instrument in a first coordinate system. Similarly, while transformed position and orientation data is describe herein, it should be appreciated that, in some embodiments, the transformed position and orientation data can be replaced by transformed position data indicative of only a transformed position (and not a transformed orientation) of a surgical instrument in a second coordinate system.

The communications module 40 receives the first raw image data (RID #1) 68 and sends corresponding RID #1 38, the same as or similar to the RID #1 68, to the registration module 32. In operation, from the P&O #1 data 26 and the RID #1 data 38, the registration module 32 can generate a first registration matrix (RM #1) 44 (also referred to herein as first registration matrix data), which is received by the viewing module 46. The registration module 32 also provides a first registration matrix (RM #1) 36, the same as or similar to the RM #1 44, to the communications module 40, which provides the first registration matrix (RM #1) 66, the same as or similar to the RM #1 44, for transport on the network 70. The first registration matrices 44, 36 can be provided once or from time to time.

As described above, a registration matrix will be understood to provide information to convert the first P&O data (P&O #1) 26 from a first coordinate system to a second coordinate system generally aligned with the coordinates system of the first raw image data (RID #1) 38. A variety of techniques are known which can result in the first registration matrix 44. For example, the primary surgical instrument can be positioned sequentially at “fiducial” points corresponding to features of the anatomy of the patient 20. The positions (in the first coordinate system) of the primary surgical instrument at the fiducial points can then be compared to positions (in the second coordinate system) of the anatomical features in the first raw image data (RID #1) 38, and transformed to those positions. The transformations can provide a mapping such that any position and orientation of the surgical instrument in the first P&O data 26 (in the first coordinate system) can be transformed to first transformed positions and orientations in the first TP&O data 54 (in the second coordinate system). One of ordinary skill in the art will recognize other methods of obtaining the registration matrix.

As described above, the first registration matrix (RM #1) 44 provides information that allows the first P&O data (P&O #1) 26 to be transformed from a first (tracker) coordinate system to a second (image) coordinate system associated with the first raw image data 38. In particular, the transformation module (TM) 50 combines the first registration matrix 44 with the first P&O data 26 to provide first transformed position and orientation (TP&O #1) data to the fusing module 52, and also to provide the TP&O #1 data 54 to the communications module 40.

In turn, the communications module 40 provides the TP&O #1 data 62, the same as or similar to the TP&O #1 data 54, for transport on the network 70.

The viewing module 46, in at least two different modes of operation, can provide at least two different tracking images. In a first mode of operation, the fusing module combines the TP&O #1 data 54, generated by the transformation module 50, and the first raw image data (RID #1) 42, which are both in the second (image) coordinate system. The combining generates fused image data 84, which can be displayed on the display device 86 as the above-described primary tracking image. For example, in one particular embodiment, as described above, the primary tracking image is an overlay of a representation of the TP&O #1 data 54 with the RID #1 42. However, other combinations are also possible.

It should be apparent that the primary tracking image can be achieved by a combination of the TP&O #1 data 54 with the RID #1 data 42, which is equivalent to a combination of the P&O #1 data 26, with the RM #1 data 44 and the RID #1 data 42.

In a second mode of operation, the viewing module 46 can also receive second TP&O data (TP&O #2) 56, which can be the same as or similar to the TP&O #2 data 60 received by the communications module 40 from the network 70. By combining the TP&O #2 data 60, which is also in the second (image) coordinate system, with the RID #1 data 42, a secondary tracking image can be generated upon the display device 86. While the primary tracking image is representative of a transformed position and orientation of a primary surgical instrument being used to perform an operation upon the patient 20, it will become apparent from discussion below in conjunction with FIG. 1B, that the secondary tracking image can be representative of a transformed position and orientation of a secondary surgical instrument being used to perform an operation upon a different patient, for example a phantom patient 262 of FIG. 1B.

As described above, the communications module 40 receives the first raw tracking data (RTD #1) 18, the first raw image data (RID #1) 68, and, in some embodiments, the second transformed position and orientation (TP&O #2) data 60, from the network 70. The communications module provides the first registration matrix (RM #1) data 66, the first position and orientation (P&O #1) data 64, and the first transformed position and orientation (TP&O #1) data 62 for transport on the network 70. In some embodiments, the tracking system 16 can provide the RTD #1 18 to the network, and, in some embodiments, the image generator 94 can provide the RID #1 68 to the network.

In other arrangements, the RID #1 68 and the RTD #1 18 are provided directly to the primary imaging and tracking system 22, and the primary imaging and tracking system 22 provides the RID #1 68 and the RTD #1 18 to the network 70. The network 70 transports RID #1 68, RTD #1 18, RM #1 66, P&O #1 data 64, TP&O #1 data 62, and TP&O #2 data 60.

While the system 10 is described to receive the first raw image data (RID #1) 68, which is in the second (image) coordinate system, it will be appreciated from discussion below in conjunction with FIG. 1A, that the system 10 can receive a plurality of raw images, each in a different coordinate system. Using techniques such as those described below, the plurality of images can each be transformed to a single second (image) coordinate system. Therefore, the display device 86 can display, either simultaneously or sequentially, a variety of different tracking images, each tracking image fused with different raw image data.

Referring now to FIG. 1A, in which like elements of FIG. 1 are shown having like reference designations (in particular, signals 18 and 60-68 transported on the network 70), a system 150 can be at a location apart from the system 10 of FIG. 1, which is generally within an operating room. The system 150 can be in the same building as the system 10, in another building, or in any other country of the world. However, the system 150 can also be within the operating room with the patient 20 of FIG. 1.

The system 150 can include a secondary imaging and tracking system 151 having a communications module 170 coupled via the network 70 to a second image data repository 208. The second image data repository 208 can provide second raw image data (RID #2) 210, which can be transported on the network 70 and received by the communications module 170. The second raw image data 210 can include image data associated with other stored images of the patient 20 of FIG. 1. The stored image(s) associated with the second raw image data 210 can be of type described above in conjunction with the image data repository 102 of FIG. 1, but the stored image data 210 need not represent the same type of image. For example, a stored image associated with the first raw image data 68 of FIG. 1 can be a CT image, and a stored image associated with the second raw image data 210 can be an MRI image.

The communications module 170 is further adapted to receive at least one of the first raw tracking data (RTD #1) 18, the first raw image data (RID #1) 68, the second transformed position and orientation data (TP&O #2) 60, the first registration matrix data (RM #1) 66, the first position and orientation (P&O #1) data 64, or the first transformed position and orientation (TP&O #1) data 62 for transport on the network 70. The TP&O #2 60 is described more fully below in conjunction with FIG. 1B.

The secondary imaging and tracking system 151 can further include a P&O module 152 coupled to the communications module 170, an image transformation module 160 coupled to the communications module 170, and a viewing module 172 coupled to the communications module 170, to the image transformation module 172, and to the P&O module 152. The viewing module 172 can be further coupled to an imaging device 192, for example, a computer monitor. The viewing module 172 can include a transformation module 180 and a fusing module 182.

In operation, the communications module 170 receives the RTD #1 18 transported by the network 70 and sends corresponding RTD #1 158, the same as or similar to the RTD #1 18, to the P&O module 152. The P&O module 152 processes the RTD #1 158 with a tracking algorithm, to provide P&O #1 data 156 to the viewing module 172. In some arrangements, the tracking algorithm used by the P&O module 152 is the same as or similar to the tracking algorithm used by the P&O module 24 of FIG. 1 (i.e., approved by the FDA). However, in other arrangements, the P&O module 152 can include another tracking algorithm (e.g., an experimental tracking algorithm not approved by the FDA), wherein the P&O module 152 can provide experimental P&O data 154 to the viewing module 172.

In operation, the image transformation module 160 receives first raw image data (RID #1) 166 from the communications module 170, which is the same as or similar to the first raw image data 68 transported on the network 70, and also receives second raw image data (RID #2) 162 from the communications module 170, which is the same as or similar to the second raw image data 210 transported on the network 70. As described above, the first raw image data 166 is in a second (image coordinate system), but the second raw image data 210 may be in another coordinate system.

In operation, the image transformation module 160 transforms the second raw image data (RID #2) 162 to transformed second raw image data (trans RID #2) 164, which is communicated to the viewing module 172. The transformed second raw image data 164 is transformed to be in the second coordinate system of the first raw image data (RID #1) 166. A variety of known algorithms can provide this transformation, and thus, are not discussed further herein. However, in one particular embodiment, the transformation is provided by Advantage Workstation VolumeShare™ software application with an image fusion module, by GE HealthCare, Buc, France.

As described above in conjunction with FIG. 1, the system 10 of FIG. 1 can receive a variety of images and associated raw image data. In some embodiments, the system 10 can include an image transformation module (not shown), the same as or similar to the image transformation module 160, which can register all of the raw images to the second (image) coordinate system.

The communications module 170 also provides at least one of P&O #1 data 188, the same as or similar to the P&O #1 data 64, TP&O #1 data 186, the same as or similar to the TP&O #1 data 62, TP&O #2 data 178, the same as or similar to the TP&O #2 data 60, RM #1 data 184, the same as or similar to the RM #1 data 66, or the RID #1 166, the same as or similar to the RID #1 68, to the viewing module 172.

As described above, the first registration matrix (RM #1) data 168 provides information that allows the first P&O (P&O #1) data 156 (and/or the experimental P&O data 154) to be transformed from a first (tracker) coordinate system to a second (image) coordinate system associated with the first raw image data (RID #1) 166. In particular, the transformation module (TM) 180 is adapted to combine the first registration matrix (RM #1) 184 with the first P&O data 156 (and/or with the experimental P&O data 154) to provide internal TP&O data (not shown) to the fusing module 182 (and/or internal experimental TP&O data, also not shown).

It will be appreciated that the P&O #1 data 156 generated by the P&O module 152 is equivalent to the P&O #1 data 188, received from the network 70, and the two may be used interchangeably. It should also be appreciated that the above-described internal TP&O is equivalent to the first transformed P&O (TP&O #1) 186, received from the network 70, and the two may be used interchangeably.

The viewing module 172, in at least six different modes of operation, can provide at least six different secondary tracking images upon the display device 192. In a first mode of operation, the fusing module 182 combines the internal TP&O data (not shown) and the transformed second raw image data (Trans RID #2) 164, which are both in the second (image) coordinate system. The combining generates fused image data 190, which can be displayed on the display device 192 as a secondary tracking image. For example, in one particular embodiment, the secondary tracking image is an overlay of a representation of the internal TP&O data (not shown) with the transformed second raw image data 164. However, other combinations are also possible.

In a second mode of operation, the fusing module 182 can use the RID #1 166 instead of the transformed secondary raw image data 164. For example, in one particular embodiment, the secondary tracking image is an overlay of a representation of the internal TP&O data (not shown) with the first raw image data 166, to provide another secondary tracking image. It will be appreciated that, in this mode of operation, the secondary tracking image is the same as the primary tracking image described in conjunction with FIG. 1.

In a third mode of operation, the experimental P&O data 154 can be transformed to internal experimental TP&O data (not shown) in the second coordinate system by the transformation module 180. Therefore, in the third mode of operation, the fusing module 182 can combine the internal experimental TP&O data with the transformed second raw image data 164, to provide another secondary tracking image.

In a fourth mode of operation, the fusing module 182 can combine internal experimental TP&O data (not shown) with the first raw image data 166, to provide another secondary tracking image.

In a fifth mode of operation, the fusing module 182 can combine the second transformed position and orientation (TP&O #2) data 178 with the transformed second raw image data 164, to provide another secondary tracking image.

In a sixth mode of operation, the fusing module 182 can combine the second transformed position and orientation (TP&O #2) data 178 with the first raw image data (RID #1) 166, to provide yet another secondary tracking image. The second transformed position and orientation data is described below in conjunction with FIG. 1B.

In some arrangements described above (third and fourth modes of operation), the experimental tracking image can be indicative of an experimental transformed position and orientation of the primary surgical instrument combined with a selected one of the first raw image data or the transformed second raw image data. However, in some other arrangements, the system 150 can be used instead to provide experimental visualizations by way of the viewing module 172. Therefore, in some embodiments, the experimental tracking image can be indicative of an experimental visualization of the first transformed position and orientation data associated with the primary surgical instrument combined with a selected one of the first raw image data or the transformed second raw image data. The experimental visualizations can also be used in conjunction with any of the above-described modes of operation

Referring now to FIG. 12B, in which like elements of FIG. 1 are shown having like reference designations (in particular, signals 18 and 60-68 transported on the network 70), a system 250 can be at a location apart from the system 10 of FIG. 1 and the system 150 of FIG. 1A. The system 250 can be in the same building as the system 10, in another building, or in any other country of the world. However, the system 250 can also be within the operating room with the patient 20 of FIG. 1.

The system 250 can include tracking sensor(s) 252 coupled to provide tracking analog signal(s) 254 to a tracking system 256. The tracking sensors 252 can be the same as or similar to the tracking sensors 12 of FIG. 1. The tracking system 256 can be the same as or similar to the tracking system 16 of FIG. 1.

The tracking system 256 can be adapted to receive the TSAs and to generate second raw tracking data (RTD #2) 258, which, in some embodiments, can be received via the network 70 by a communications module 288 within a secondary imaging and tracking system 260. In some other arrangements, the RTD #2 258 is provided directly to the secondary imaging and tracking system 260 via a direct link.

The tracking sensors 252 and associated second raw tracking data (RTD #2) 258 can include tracking data representative of a position and orientation of a secondary surgical instrument used by a technician in a simulated surgical procedure upon a phantom patient 262. With this arrangement, the consulting surgeon or technician performing the simulated surgical procedure can essentially guide a surgeon performing the primary surgical procedure in conjunction with the system 10 of FIG. 1, since, as described in conjunction with FIG. 1 as described below, an image associated with second transformed position and orientation (TP&O #2) data (i.e., a transformed position and orientation of the secondary surgical instrument) can be displayed upon both the display device 86 of FIG. 1 and also a display device 304 (and also upon the display device 192 of FIG. 1A).

The communications module 288 is further adapted to receive at least one of the RTD #1 18, the RID #1 68, the first registration matrix (RM #1) data 66, the first position and orientation (P&O #1) data 64, or the first transformed position and orientation (TP&O #1) data 62 from the network 70. The communications module 288 is also adapted to provide the second transformed position and orientation data (TP&O #2) 60 for transport on the network. The TP&O #2 60 is described more fully below.

The secondary imaging and tracking system 260 can further include a P&O module 264 coupled to the communications module 188, a registration module 274 coupled to the communications module 288 and to the P&O module 264, and a viewing module 290 coupled to the communications module 288, to the registration module 274, and to the P&O module 264. The viewing module 290 can be further coupled to the imaging device 304, for example, a computer monitor.

The registration module 274 can include a registration matrix module 276. The viewing module 290 can include a transformation module 294 and a fusing module 296.

The communications module 288 can receive the RTD #1 18 transported by the network 70 and send corresponding RTD #1 272, the same as or similar to the RTD #1 18, to the P&O module 264. The P&O module 264 processes the RTD #1 272 with a tracking algorithm to provide P&O #1 data 266 to the viewing module 290. The communications module 288 can also receive the RTD #2 258 transported by the network 70 and send corresponding RTD #2 270, the same as or similar to the RTD #2 258, to the P&O module 264. The P&O module 264 processes the RTD #2 270 with a tracking algorithm to provide P&O #2 data 268 to the viewing module 290.

It will be appreciated that the P&O #1 data 266 is indicative of a position and orientation of the primary surgical instrument used in a surgical procedure upon the patient 20 of FIG. 1. Conversely, it will be appreciated that the P&O #2 data 268 is indicative of a position and orientation of the secondary surgical instrument used in a simulated surgical procedure upon the phantom patient 262 of FIG. 1B.

A generic phantom patient 262 having specific generic anatomy can be used to create a “coarse” registration matrix (not shown) between real anatomic patient image data, e.g., the first the raw image data (RID #1) 68, and the generic phantom. However, it is also possible to fabricate the phantom patient 262 to have the same anatomical features at the real patient 20 of FIG. 1, resulting in a better “fine” registration with the actual patient 20.

In some arrangements, the tracking algorithm used by the P&O module 264 is the same as or similar to the tracking algorithm used by the P&O module 24 of FIG. 1.

The communications module 288 receives the RID #1 68 and sends corresponding RID #1 278, the same as or similar to the RID #1 68, to the registration module 274. In operation, from the P&O #2 data 268 and the RID #1 data 278, the registration module 274 generates a second registration matrix RM #2 284 (also referred to herein as registration matrix data), which is received by the viewing module 290.

It will be appreciated that the second registration matrix 284 provides information that allows the second P&O data 268 to be transformed from another first (tracker) coordinate system to the second (image) coordinate system associated with the first raw image data (RID #1) 278. In particular, the transformation module (TM) 294 combines the second registration matrix 284 with the second P&O (P&O #2) data 268 to provide second transformed P&O (TP&O #2) data 298 to the fusing module 296, and also to provide the TP&O #2 data 298 to the communications module 288. In turn, the communications module 288 provides the TP&O #2 data 60, the same as or similar to the TP&O #2 data 298, for transport on the network 70. The second transformed position and orientation (TP&O #2) data 298, 60 is indicative of a position and an orientation of the secondary surgical instrument used in the simulated surgical procedure upon the phantom patient. TP&O #2 298, 60 is in the second (image) coordinate system of the first raw image data (RID #1) 278, 286, 68.

The viewing module 290, in at least two different modes of operation, can provide at least two different secondary tracking images upon the display device 304. In a first mode of operation, the fusing module 296 combines the second TP&O (TP&O #2) data 298 and the first raw image data (RID #1) 286, which are both in the second (image) coordinate system. The combining generates fused image data 302, which can be displayed on the display device 304 as a secondary tracking image. For example, in one particular embodiment, the secondary tracking image is an overlay of a representation of the second TP&O #2 data 298 with the first raw image data 286. However, other combinations are also possible.

It will be appreciated that the above-described first mode of operation of the system 250 provides the same secondary tracking image as the sixth mode of operation of the system 150 of FIG. 1A and the same as the second mode of operation of the system 10 of FIG. 1.

In a second mode of operation, the fusing module 296 can use the TP&O #1 data 300 (or equivalently, the P&O #1 data 280 in combination with the RM #1 282, or equivalently the P&O #1 data 266 in combination with the RM #1 282) instead of the transformed second P&O (TP&O #2) data 298. For example, in one particular embodiment, the secondary tracking image is an overlay of a representation of the first TP&O data 300 with the first raw image data 286, to provide another secondary tracking image. It will be appreciated that, in this mode of operation, the secondary tracking image upon the display device 304 is the same as the primary tracking image described in conjunction with the first mode of operation of the system 10 of FIG. 1, which is the same as the image generated in the second mode of operation of the system 150 of FIG. 1A.

While FIGS. 1, 1A, and 1B depict certain particular arrangements, other arrangements are also possible. For example, the tracking system 16, 256 of FIGS. 1 and 1B, respectively, could be within the respective imaging and tracking systems 22, 260, respectively. Also, While certain signals are shown to be transported on the network 70, in other arrangements, fewer than those signal shown can be transported on the network 70, which may or may not result in fewer modes of operation.

All references cited herein are hereby incorporated herein by reference in their entirety.

Having described preferred embodiments of the invention, it will now become apparent to one of ordinary skill in the art that other embodiments incorporating their concepts may be used. It is felt therefore that these embodiments should not be limited to disclosed embodiments, but rather should be limited only by the spirit and scope of the appended claims.

What is claimed is:

1. A method of generating a tracking image, comprising:
receiving first raw image data with a primary imaging and tracking system;
communicating upon a network at least one of the first raw image data, first raw tracking data, first position and orientation data, first transformed position and orientation data, or first registration matrix data, wherein the first position and orientation data is associated with a first coordinate system, wherein the first raw image data is associated with a second coordinate system, wherein the first raw tracking data is representative of raw information provided by a first tracking sensor adapted to track a primary surgical instrument, wherein the first position and orientation data is indicative of a position and orientation of the primary surgical instrument in the first coordinate system, wherein the first transformed position and orientation data is indicative of a transformed position and orientation of the primary surgical instrument in the second coordinate system, and wherein the first registration matrix data is representative of a transformation from the first coordinate system to the second coordinate system; and
displaying with the primary imaging and tracking system a primary tracking image indicative of the first transformed position and orientation data associated with the primary surgical instrument combined with the first raw image data.

2. The method of claim 1, further comprising receiving from the network with a secondary imaging and tracking system at least one of the first raw image data, the first raw tracking data, the first position and orientation data, the first transformed position and orientation data, or the first registration matrix data.

3. The method of claim 2, further comprising displaying with the secondary imaging and tracking system a second version of the primary tracking image.

4. The method of claim 2, further comprising:
receiving from the network second raw image data with the secondary imaging and tracking system, wherein the second raw image data is associated with a third coordinate system;
transforming the second raw image data to provide transformed second raw image data, wherein the transformed second raw image data is associated with the second coordinate system; and
displaying with the secondary imaging and tracking system a secondary tracking image indicative of the first transformed position and orientation data associated with the primary surgical instrument combined with the transformed second raw image data.

5. The method of claim 4, further comprising displaying with the secondary imaging and tracking system an experimental tracking image different from the primary and secondary tracking images, wherein the experimental tracking image is indicative of at least one of an experimental transformed position and orientation of the primary surgical instrument combined with a selected one of the first raw image data or the transformed second raw image data, an experimental visualization of the first transformed position and orientation data associated with the primary surgical instrument combined with a selected one of the first raw image data or the transformed second raw image data.

6. The method of claim 2, further comprising:
receiving from the network with the secondary imaging and tracking system second raw tracking data, wherein the second raw tracking data is representative of raw information provided by second tracking sensors adapted to track a secondary surgical instrument; and
displaying with the secondary imaging and tracking system a secondary tracking image indicative of second transformed position and orientation data associated with the secondary surgical instrument combined with the first raw image data, wherein the second transformed position and orientation data is indicative of a transformed position and orientation of the secondary surgical instrument in the second coordinate system.

7. The method of claim 6, further comprising displaying with the secondary imaging and tracking system a second version of the primary tracking image.

8. The method of claim 6, further comprising:
communicating to the network with the secondary imaging and tracking system the second transformed position and orientation data;
receiving from the network the second transformed position and orientation data with the primary imaging and tracking system; and
displaying with the primary imaging and tracking system a second version of the secondary tracking image.

9. System for generating a tracking image, comprising:
a primary imaging and tracking system adapted to:
receive first raw image data,
communicate upon a network at least one of the first raw image data, first raw tracking data, first position and orientation data, first transformed position and orientation data, or first registration matrix data, wherein the first position and orientation data is associated with a first coordinate system, wherein the first raw image data is associated with a second coordinate system, wherein the first raw tracking data is representative of raw information provided by tracking sensors, wherein the first position and orientation data is indicative of a position and orientation of a primary surgical instrument in the first coordinate system, wherein the first transformed position and orientation data is indicative of a transformed position and orientation of the primary surgical instrument in the second coordinate system, and wherein the first registration matrix data is representative of a transformation from the first coordinate system to the second coordinate system, and
display a primary tracking image indicative of the first transformed position and orientation data associated with the primary surgical instrument combined with the first raw image data.

10. The system of claim 9, further comprising a secondary imaging and tracking system adapted to receive from the network at least one of the first raw image data, the first raw tracking data, the first position and orientation data, the first transformed position and orientation data, or the first registration matrix data.

11. The system of claim 10, wherein the secondary imaging and tracking system is further adapted to display a second version of the primary tracking image.

12. The system of claim 10, wherein the secondary imaging and tracking system is further coupled to receive from the network second raw image data associated with a third coordinate system, wherein the secondary imaging and tracking system is adapted to transform the second raw image data to provide transformed second raw image data associated with the second coordinate system, wherein the secondary imaging and tracking system is further adapted to display a secondary tracking image indicative of the first transformed position and orientation data associated with the primary surgical instrument combined with the transformed second raw image data.

13. The system of claim 12, wherein the secondary imaging and tracking system is further adapted to display an experimental tracking image different from the primary or secondary tracking images, which is indicative of at least one of an experimental transformed position and orientation of the primary surgical instrument combined with a selected one of the first raw image data or the transformed second raw image data, or an experimental visualization of the first transformed position and orientation data associated with the primary surgical instrument combined with a selected one of the first raw image data or the transformed second raw image data.

14. The system of claim 10, wherein the secondary imaging and tracking system is further coupled to receive from the network second raw tracking data, wherein the second raw tracking data is representative of raw information provided by a second tracking sensor adapted to track a secondary surgical instrument, and wherein the secondary imaging and tracking system is adapted to display a secondary tracking image indicative of second transformed position and orientation data associated with the secondary surgical instrument combined with the first raw image data, wherein the second transformed position and orientation data is indicative of a transformed position and orientation of the secondary surgical instrument in the second coordinate system.

15. The system of claim 14, wherein the secondary imaging and tracking system is further adapted to display a second version of the primary tracking image.

16. The system of claim 14, wherein the secondary imaging and tracking system is further adapted to communicate to the network the second transformed position and orientation data, and wherein the primary imaging and tracking system is further adapted to receive from the network the second transformed position and orientation data and to display a secondary version of the secondary tracking image.

17. The system of claim 10, wherein the secondary imaging and tracking system comprises:
a secondary communications module adapted to couple to the network, wherein the secondary communications module is coupled to receive from the network at least one of second raw image data, the first raw image data, the first raw tracking data, the first registration matrix data, the first position and orientation data, or the first transformed position and orientation data;
a secondary position and orientation module coupled to receive the first raw tracking data and adapted to generate at least one of a second version of the first position and orientation data or experimental position and orientation data;
an image transformation module coupled to receive the first raw image data and the second raw image data, and adapted to generate transformed second raw image data, wherein the transformed second raw image data is associated with the second coordinate system; and
a secondary viewing module coupled to receive at least one of the second version of the first position and orientation data, the experimental position and orientation data, the first registration matrix data, the first position and orientation data, the first raw image data, the transformed second raw image data, or the first transformed position and orientation data, and adapted to generate at least one of a second version of the primary tracking image, a secondary tracking image indicative of the first transformed position and orientation data associated with the primary surgical instrument combined with the second raw image data, or an experimental tracking image different from the primary or secondary tracking images, which is indicative of an experimental transformed position and orientation of the primary surgical instrument combined with at least one of the first or the second raw image data.

18. The system of claim 10, wherein the secondary imaging and tracking system comprises:
a secondary communications module adapted to couple to the network, wherein the secondary communications module is coupled to receive at least one of the first raw image data, the first raw tracking data, second raw tracking data, the first registration matrix data, the first position and orientation data, or the first transformed position and orientation data;
a secondary position and orientation module coupled to receive at least one of the first raw tracking data or the second raw tracking data, and adapted to generate at least one of a second version of the first position and orientation data or second position and orientation data;
a secondary registration module coupled to receive from the network the second position and orientation data and the first raw image data, and adapted to generate second registration matrix data; and
a secondary viewing module coupled to receive at least one of the second version of the first position and orientation data, the second position and orientation data, the first registration matrix data, the second registration matrix data, the second position and orientation data, the first raw image data, or the first transformed position and orientation data, and adapted to generate at least one of secondary tracking image indicative of a the second transformed position and orientation data associated with the secondary surgical instrument combined with first raw image data or a second version of the primary tracking image.

19. The system of claim 9, wherein the primary imaging and tracking system comprises:
a primary communications module adapted to couple to the network, wherein the primary communications module is coupled to receive at least one of the first raw image data or the first raw tracking data;
a primary position and orientation module coupled to receive the first raw tracking data and adapted to generate the first position and orientation data;
a primary registration module coupled to receive the first position and orientation data and the first raw image data, and adapted to generate the first registration matrix data; and
a primary viewing module coupled to receive from the network at least one of the first position and orientation data, the first registration matrix data, or the first raw image data, wherein the primary viewing module is further adapted to generate the first transformed position and orientation data, and wherein the primary viewing module is further adapted to combine the first transformed position and orientation data with the first raw image data to generate the primary tracking image.

20. System for generating a tracking image, comprising:
a primary imaging and tracking system adapted to couple to a network and adapted to communicate tracking data to or from the network, wherein the tracking data is associated with a position and an orientation of a surgical instrument.

21. The system of claim 20, wherein the tracking data includes at least one of first raw image data, first raw tracking data, first registration matrix data, first position and orientation data, first transformed position and orientation data, and second transformed position and orientation data, wherein the first position and orientation data is associated with a first coordinate system, wherein the first raw image data is associated with a second coordinate system, wherein the first raw tracking data is indicative of a position and orientation of a primary surgical instrument, the first position and orientation data is indicative of a position and orientation of the primary surgical instrument in the first coordinate system, the first transformed position and orientation data is indicative of a transformed position and orientation of the primary surgical instrument in the second coordinate system, the first registration matrix data is representative of a transformation from the first coordinate system to the second coordinate system, and the second transformed position and orientation data is indicative of a transformed position and orientation of a secondary surgical instrument in the second coordinate system.

22. The system of claim 20, further comprising a secondary imaging and tracking system adapted to couple to the primary imaging and tracking system via the network, wherein the primary imaging and tracking system and the secondary imaging and tracking system are adapted to exchange the tracking data.

23. Method of generating a tracking image, comprising:
communicating tracking data to or from a network associated with a primary imaging and tracking system, wherein the tracking data is associated with a position and an orientation of a surgical instrument.

24. The method of claim 23, wherein the tracking data includes at least one of the first raw image data, first raw tracking data, first position and orientation data, first transformed position and orientation data, second transformed position and orientation data, or first registration matrix data, wherein the first position and orientation data is associated with a first coordinate system, wherein the first raw image data is associated with a second coordinate system, wherein the first raw tracking data is representative of raw information provided by a first tracking sensor adapted to track a primary surgical instrument, wherein the first position and orientation data is indicative of a position and orientation of the primary surgical instrument in the first coordinate system, wherein the first transformed position and orientation data is indicative of a transformed position and orientation of the primary surgical instrument in the second coordinate system, wherein the first registration matrix data is representative of a transformation from the first coordinate system to the second coordinate system, and wherein the second transformed position and orientation data is indicative of a transformed position and orientation of a secondary surgical instrument in the second coordinate system.

25. The method of claim 23, further comprising exchanging the tracking data via the network, between the primary imaging and tracking system and a secondary imaging and tracking system coupled to the network.
